(19) United States
(12) Patent Application Publication
(10) Pub. No.: US 2020/0397054 A1
(43) Pub. Date: Dec. 24, 2020

(54) AEROSOL-GENERATING DEVICE WITH FEEDBACK CONTROL

(71) Applicant: Philip Monrris Products S.A., Neuchatel (CH)

(72) Inventors: Riccardo RIVA REGGIORI, St.-Sulpice (CH); Michel BESSANT, Neuchatel (CH); Ana Isabel GONZALEZ FLOREZ, St.-Sulpice (CH)

(73) Assignee: Philip Monrris Products S.A., Neuchatel (CH)

(21) Appl. No.: 16/772,477

(22) PCT Filed: Dec. 10, 2018
(86) PCT No.: PCT/EP2018/084204

§ 371 Date: Jun. 12, 2020

(30) Foreign Application Priority Data
Dec. 13, 2017 (EP) 17207157.3

(51) Int. Cl. A24F 40/53; A24F 40/51; A24F 40/57; G05B 19/4155

(52) U.S. Cl. CPC A24F 40/53; A24F 40/51; A24F 40/20; G05B 19/4155; A24F 40/57

(57) ABSTRACT

An aerosol-generating device is provided, including: a heating element configured to heat an aerosol-forming substrate to generate an aerosol; a temperature sensor configured to measure a temperature of the heating element; an aerosol-monitor for measuring an aerosol property including at least one of a physical property and a chemical composition of a generated aerosol, the aerosol-monitor being disposed at or along a flow channel downstream of the heating element; a controller configured to adjust a power supplied to the heating element based on: i) a measured heating element temperature in a first feedback control loop, and ii) a measured aerosol property in a second feedback control loop; and an auxiliary aerosol controller for adjusting aerosol properties of the generated aerosol, the controller is further configured to adjust at least one control variable for the auxiliary aerosol controlling means based on the measured aerosol property in the second feedback control loop.

The present invention relates to an aerosol-generating device with feedback control.

Handheld electrically operated aerosol-generating systems commonly generate aerosol by heating an aerosol-forming substrate with a resistive heating element, to release volatile compounds in a vapour that subsequently cools to form an aerosol. Controlling the maximum temperature of the heating element prevents the release of undesirable chemical compounds, such as those commonly found in conventional cigarette smoke, which are formed at high temperatures. Thus, the temperature of the heating element is normally the only control variable for controlling the quality of the generated aerosol. The temperature of the heating element is often determined by detecting an electrical resistance of the heating element. However, the measured resistance provides an indication of temperature across the entire heating element and thus it may not detect localised overheating.

Moreover, the quality of the generated aerosol may differ from one device to another, as well as from one type of aerosol-forming substrate to another. The performance of the aerosol-generating system may also depend upon other factors such as puff intensity, puff duration and device maintenance. Currently available devices typically do not take account of these factors to provide consistent aerosol quality, nor they are able to react to misuse or failure of components in the device.

In addition, because these prior art devices typically provide heater control based on pre-defined correlations and set control profiles, there is a limited ability to provide for customisation of the heater control to generate aerosol that is best suited to a user's individual desires.

It is therefore desirable to provide an aerosol-generating system which is able to provide an improved heater control mechanism.

According to a first aspect of the present invention there is provided an aerosol-generating device comprising: a heating element configured to heat an aerosol-forming substrate for generating an aerosol; a temperature sensor for measuring a temperature of the heating element; an aerosol monitoring means for measuring an aerosol property comprising at least one of a physical property and a chemical composition of the generated aerosol; and a controller configured to adjust a power supplied to the heating element based on i) the measured temperature of the heating element in a first feedback control loop; and ii) the measured aerosol property in a second feedback control loop.

The measured aerosol property may comprise one or more aerosol properties. The aerosol monitoring means may comprise a sensor for monitoring at least one physical property or a chemical composition of the generated aerosol. The sensor may be positioned at or along a flow channel downstream of the heating element. The physical property of the generated aerosol may comprise any one or more of droplet density, droplet size, droplet velocity, and volumetric flow rate of the generated aerosol. The chemical composition may comprise any one or more of undesirable chemical compound level, combustion gas level, and nicotine level.

The temperature sensor may be a dedicated temperature sensor such as a thermocouple. Preferably, the heating element may be used as a temperature sensor. For example the heater may be used as a resistance temperature detector (RTD). A measured electrical resistance may be correlated to a temperature.

By monitoring the aerosol properties of the generated aerosol, the controller may adopt more sophisticated feedback control mechanisms. For example, if the temperature of the generated aerosol is used as an input, in addition to the measured heater temperature, it may allow the controller to fine tune the quality of generated aerosol, as well as to react to an abnormal condition.

The first feedback control loop and the second feedback control loop may work together to control the heating element temperature. For example, the control of the power supplied to the heating element may be based on the measured aerosol properties in the second feedback control loop, whilst the first feedback loop is used to ensure that the heater temperature does not exceed a predetermined maximum temperature.

The controller may be configured to compare a measured aerosol property with an expected aerosol property to determine if there is an abnormal condition. An abnormal condition may be defined as occurring when the measured aerosol property differs from an expected or desired value or range of values for that property. If the measured aerosol property is within the expected or desired range then it can be considered to be a normal condition for that aerosol property. The expected or desired range or target value for each measured aerosol property may be adjustable by the user. The expected or desired range or target value for each measured aerosol property may be different for different aerosol-forming substrates. The expected or desired range or target value for each measured aerosol property may be dependent on other measured parameters. For example the expected or desired range of aerosol temperature may be dependent on ambient temperature or humidity. The expected or desired aerosol density maybe dependent on a user selected device setting. The expected or desired aerosol property or properties may be stored in a memory in the controller.

The controller may be configured to adjust the power based on the first feedback loop if there is no abnormal condition and to adjust the power based on the second feedback control loop if there is an abnormal condition. Activating the second feedback control loop only upon the detection of at least one abnormal aerosol condition, allows a simple controller to be used because it does not require cross referencing the measured aerosol property with the heating element temperature.

The aerosol-generating device may comprise an auxiliary aerosol controlling means for varying aerosol properties of the generated aerosol; and the controller is configured to adjust at least one control variable for the auxiliary aerosol controlling means based on the measured aerosol properties in the second feedback control loop. The auxiliary aerosol controlling means may advantageously provide further adjustment and control of aerosol properties after the aerosol is formed or during aerosol formation. The auxiliary aerosol controlling means may comprise any mechanism that impacts aerosol formation, aerosol physical properties and chemical compositions known to the person skilled in the art, for example temperature and pressure controlling means, mechanical filters and chemical absorbers.

The auxiliary aerosol controlling means may be configured to cool the generated aerosol. For example, the auxiliary aerosol controlling means may comprise at least one of a thermoelectric device, a heat exchanger, a heat pump or a heat sink. The temperature of the generated aerosol has a significant impact on the formation and growth of the aerosol droplets, and so droplet density and size. Preferably, the auxiliary aerosol controlling means comprises a thermoelectric device that may advantageously provide heating/cooling at its surface when an electrical current is applied to the thermoelectric device. Advantageously, the thermoelectric device is a Peltier device. A Peltier device typically has a simple construction, does not comprise any moving parts, and so is reliable. In addition, a Peltier device is relatively compact and lightweight, making it an ideal choice for use in handheld aerosol-generating devices.

The aerosol-generating device may comprise an aerosol-generating chamber for generating the aerosol. The auxiliary aerosol controlling means may comprise an actuator for varying a volume of the aerosol-generating chamber. This may be achieved by adjusting the length of the chamber or the shape of the aerosol-generating chamber. This may be achieved using a piezoelectric element for example. Varying the volume of the aerosol-generating chamber may change a residence time of the generated aerosol before it is drawn through a mouthpiece. This may have a significant impact on the quantity and size of the aerosol droplets.

The auxiliary aerosol controlling means may comprise a variable filter, such as a micro-impactor or a variable sieve. The variable filter may advantageously filter out oversized droplets so that the filtered aerosol droplets are within an acceptable size range. More specifically, the variable filter may change a sieve size depending on various aerosol properties. For example, the variable filter may reduce the sieve size if the droplet density is found to be abnormally high. Increased filtering reduces the aerosol concentration.

The aerosol monitoring means may comprise at least one of a spectrometer, an electro-chemical sensor and a Metal Oxide Semiconductor (MOS) sensor. The use of these chemical sensors allows undesirable chemical compositions to be detected. Upon detecting the presence of undesirable chemical composition, the controller may cut the supply of power to the heating element, or it may reduce the supply of power to the heating element to reduce the heating element temperature. Reducing heating element temperature will typically stop the production of the undesirable composition or lower the undesirable chemical composition level in the generated aerosol.

The aerosol-generating device may comprise a data receiver connected to the controller. The aerosol-generating device may comprise a data transmitter connected to the controller. The data transmitter and data receiver may allow for wireless communication with an external device. The data transmitter and receiver may comprise a Bluetooth Low energy transceiver. The controller may be configured to update expected or desired or target aerosol properties or heating element parameters based on data received through the data receiver.

The aerosol-generating device may further comprise a memory having stored thereon a predictive control algorithm or a proportional integral derivative algorithm. The controller may be configured to implement the first feedback control, or the second feedback control loop, or both the first feedback control loop and the second feedback control loop using either the predictive control algorithm or the proportional integral derivative algorithm. The predictive control algorithm may regulate variables both before and after a change in measured temperature, or measured aerosol property, or both measured temperature and measured aerosol property.

The aerosol generating system may comprise a handheld aerosol-generating device.

The handheld aerosol-generating device may be configured to generate an aerosol for user inhalation. The handheld aerosol-generating device may comprise a mouthpiece on which a user may puff to draw aerosol generated by the device out of the device. The aerosol-generating system may be a battery operated device. The aerosol-generating system may comprise a housing for holding the temperature sensor, the aerosol monitoring means, and the heating element. The housing may also partially or fully contain the substrate. The device is preferably a portable device that is comfortable to hold between the fingers of a single hand. The device may be substantially cylindrical in shape and have a length of between 70 and 200 mm. The maximum diameter of the device is preferably between 10 and 30 mm.

The aerosol-generating system provides a possibility to measure a type and/or an amount of at least one chemical composition directly and to use it in a second feedback control loop. In this regard, the system may measure an absorption spectrum of the generated aerosol. The absorption spectrum of the generated aerosol may provide an indication of the compositions present within the generated aerosol.

The heating element may be configured to heat an aerosol-forming substrate continuously during operation of the device. “Continuously” in this context means that heating is not dependent on air flow through the device, so that power may be delivered to the heating element even when there is no airflow through the device. Cooling the housing of the device is particularly desirable in continuously heated devices as the temperature of the housing may rise in periods when power is being supplied to the heating element but air is not being drawn through the device. Alternatively, the device may include means to detect air flow and the heating element may be configured to heat the aerosol-forming substrate only when the air flow exceeds a threshold level, indicative of a user drawing on the device.

As used herein, an ‘aerosol-generating device’ relates to a device that interacts with an aerosol-forming substrate to generate an aerosol. The aerosol-forming substrate may be part of an aerosol-forming article, for example part of a smoking article. An aerosol-generating device may be a smoking device that interacts with an aerosol-forming substrate of an aerosol-forming article to generate an aerosol that is directly inhalable into a user's lung through the user's mouth. An aerosol-generating device may hold an aerosol-forming article. An aerosol-forming article may be fully or partially contained in the aerosol-generating device. The aerosol-forming article may comprise a mouthpiece, on which a user may puff during use.

As used herein, the term ‘aerosol-forming substrate’ relates to a substrate capable of releasing volatile compounds that can form an aerosol. Such volatile compounds may be released by heating the aerosol-forming substrate. An aerosol-forming substrate may conveniently be part of an aerosol-forming article.

As used herein, the terms ‘aerosol-forming article’ refer to an article comprising an aerosol-forming substrate that is capable of releasing volatile compounds that can form an aerosol. For example, an aerosol-forming article may generate an aerosol that is directly inhalable into a user's lung through the user's mouth. However in contrast to a conventional cigarette the aerosol-forming article does not require combustion to generate an aerosol. An aerosol-forming article may be disposable and may be, or may comprise, a tobacco stick. As used herein, the term ‘aerosol generating system’ refers to a combination of an aerosol-generating device and one or more aerosol-forming articles for use with the device. An aerosol-generating system may include additional components, such as a charging unit for recharging an on-board electric power supply in an electrically operated or electric aerosol-generating device.

As used herein the term ‘mouthpiece portion’ refers to a portion of an aerosol-forming article or aerosol-generating device that is placed into a user's mouth in order to directly inhale an aerosol generated by the aerosol-forming article or aerosol-generating device. The aerosol is conveyed to the user's mouth through the mouthpiece.

The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum, platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may be embedded in, encapsulated or coated with an insulating material or vice-versa, depending on the kinetics of energy transfer and the external physicochemical properties required. Alternatively, the electric heaters may comprise an infra-red heating element, a photonic source, or an inductive heating element.

The aerosol-generating device may comprise an internal heating element or an external heating element, or both internal and external heating elements, where “internal” and “external” refer to the aerosol-forming substrate. An internal heater may take any suitable form. For example, an internal heater may take the form of a heating blade. Alternatively, the internal heater may take the form of a casing or substrate having different electro-conductive portions, or an electrically resistive metallic tube. Alternatively, the internal heater may be one or more heating needles or rods that run through the centre of the aerosol-forming substrate. Other alternatives include a heating wire or filament, for example a Ni—Cr (Nickel-Chromium), platinum, tungsten or alloy wire or a heating plate. The internal heating element may be deposited in or on a rigid carrier material. In one such embodiment, the electrically resistive heater may be formed using a metal having a defined relationship between temperature and resistivity. In such an exemplary device, the metal may be formed as a track on a suitable insulating material, such as a ceramic material like Zirconia, and then sandwiched in another insulating material, such as a glass. Heaters formed in this manner may be used to both heat and monitor the temperature of the heaters during operation.

An external heater may take any suitable form. For example, an external heater may take the form of one or more flexible heating foils on a dielectric substrate, such as polyimide. The flexible heating foils can be shaped to conform to the perimeter of the substrate receiving cavity. Alternatively, an external heater may take the form of a metallic grid or grids, a flexible printed circuit board, a moulded interconnect device (MID), ceramic heater, flexible carbon fibre heater or may be formed using a coating technique, such as plasma vapour deposition, on a suitable shaped substrate. An external heater may also be formed using a metal having a defined relationship between temperature and resistivity. In such an exemplary device, the metal may be formed as a track between two layers of suitable insulating materials. An external heater formed in this manner may be used to both heat and monitor the temperature of the external heater during operation.

The internal or external heater may comprise a heat sink, or heat reservoir comprising a material capable of absorbing and storing heat and subsequently releasing the heat over time to the aerosol-forming substrate. The heat sink may be formed of any suitable material, such as a suitable metal or ceramic material. In one embodiment, the material has a high heat capacity (sensible heat storage material), or is a material capable of absorbing and subsequently releasing heat via a reversible process, such as a high temperature phase change. Suitable sensible heat storage materials include silica gel, alumina, carbon, glass mat, glass fibre, minerals, a metal or alloy such as aluminium, silver or lead, and a cellulose material such as paper. Other suitable materials which release heat via a reversible phase change include paraffin, sodium acetate, naphthalene, wax, polyethylene oxide, a metal, metal salt, a mixture of eutectic salts or an alloy. The heat sink or heat reservoir may be arranged such that it is directly in contact with the aerosol-forming substrate and can transfer the stored heat directly to the substrate. Alternatively, the heat stored in the heat sink or heat reservoir may be transferred to the aerosol-forming substrate by means of a heat conductor, such as a metallic tube.

The aerosol-forming article may be substantially cylindrical in shape. The aerosol-forming article may be substantially elongate. The aerosol-forming article may have a length and a circumference substantially perpendicular to the length. The aerosol-forming substrate may be substantially cylindrical in shape. The aerosol-forming substrate may be substantially elongate. The aerosol-forming substrate may also have a length and a circumference substantially perpendicular to the length.

The aerosol-forming article may have a total length between approximately 30 mm and approximately 100 mm. The aerosol-forming article may have an external diameter between approximately 5 mm and approximately 12 mm. The aerosol-forming article may comprise a filter plug. The filter plug may be located at a downstream end of the smoking article. The filter plug may be a cellulose acetate filter plug. The filter plug is approximately 7 mm in length in one embodiment, but may have a length of between approximately 5 mm to approximately 10 mm.

In one embodiment, the aerosol-forming article has a total length of approximately 45 mm. The smoking article may have an external diameter of approximately 7.2 mm. Further, the aerosol-forming substrate may have a length of approximately 10 mm. Alternatively, the aerosol-forming substrate may have a length of approximately 12 mm. Further, the diameter of the aerosol-forming substrate may be between approximately 5 mm and approximately 12 mm. The aerosol-forming article may comprise an outer paper wrapper. Further, the aerosol-forming article may comprise a separation between the aerosol-forming substrate and the filter plug. The separation may be approximately 18 mm, but may be in the range of approximately 5 mm to approximately 25 mm.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former that facilitates the formation of a dense and stable aerosol. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. The solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

The solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other embodiments. For example, the aerosol-forming substrate may be a liquid aerosol-forming substrate. If a liquid aerosol-forming substrate is provided, the aerosol-generating device preferably comprises means for retaining the liquid. For example, the liquid aerosol-forming substrate may be retained in a container. Alternatively or in addition, the liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use of the aerosol-generating device or alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

The aerosol-generating device may further comprise a power supply for supplying power to the internal and external heaters. The power supply may be any suitable power supply, for example a DC voltage source such as a battery. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery.

In another aspect of the disclosure, there is provided an aerosol-generating system comprising a device in accordance with the first aspect of the invention, the device comprising a housing and an aerosol-forming substrate received partially or fully within the housing. According to a third aspect of the present invention, there is provided an aerosol-generating system comprising: an aerosol-forming substrate; a heating element configured to heat the aerosol-forming substrate for generating an aerosol; a temperature sensor for measuring a temperature of the heating element; an aerosol monitoring means for measuring an aerosol property comprising at least one of a physical property and a chemical composition of the generated aerosol; and a controller configured to adjust a power supplied to the heating element based on i) the measured heating element temperature in a first feedback control loop; and ii) the monitored aerosol property in a second feedback control loop.

According to a fourth aspect of the present invention, there is provided an aerosol-forming substrate for use in an aerosol generating system, comprising an aerosol monitoring means configured to monitor aerosol properties of the generated aerosol and to communicate with a controller in an aerosol-generating device.

According to a fifth aspect of the present invention, there is provided a method of controlling generation of an aerosol, the method comprising:

i) generating the aerosol from an aerosol-forming substrate with a heating element;

ii) measuring a heating element temperature at the heating element;

iii) adjusting a power supplied to the heating element based on the measured temperature in a first feedback control loop;

iv) measuring an aerosol property of the generated aerosol, wherein said aerosol property comprises at least one physical property or chemical composition of the generated aerosol;

v) comparing the one or more measured aerosol properties with an expected aerosol property to determine if there is an abnormal condition;

vi) adjusting the power supplied to the heating element based on the first feedback control loop if there is no abnormal condition; and

vii) adjusting the power supplied to the heating element based on the second feedback control loop if there is an abnormal condition.

Features described in relation to one aspect may equally be applied to other aspects of the invention.

Embodiments of the invention will now be described, by way of example only, with reference to the accompanying drawings, in which:

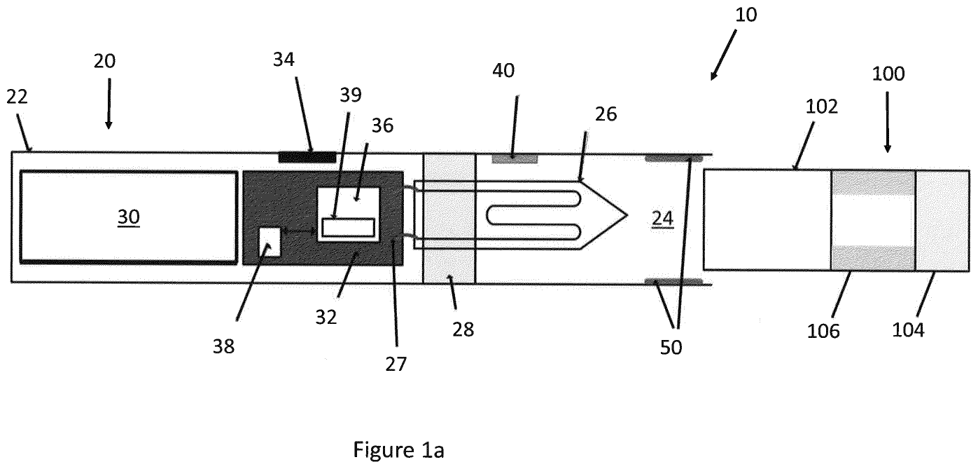

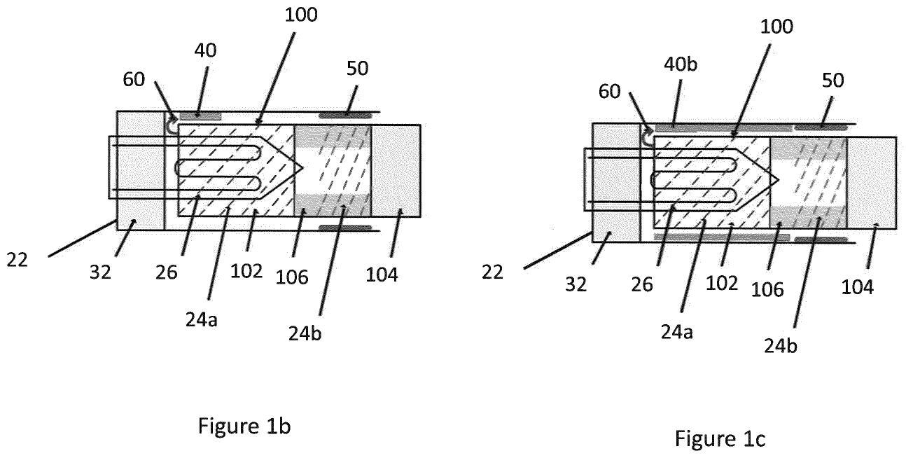

FIG. 1a is an illustrative view of an aerosol-generating system according to an embodiment of the present invention;

FIG. 1b is an illustrative view of the aerosol-generating system of FIG. 1 when it is put into operation;

FIG. 1c is an illustrative view of an alternative aerosol-generating system;

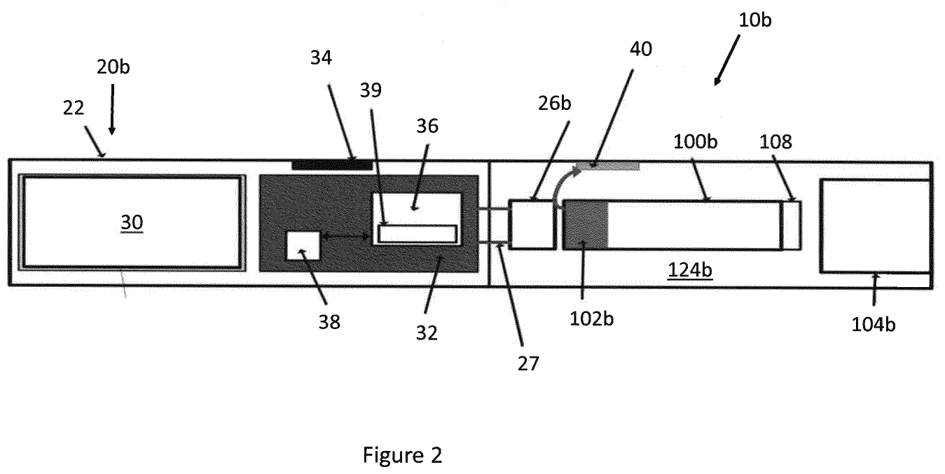

FIG. 2 is an illustrative view of an aerosol-generating system adapted for vaporizing a liquid aerosol-forming substrate according to another embodiment of the present invention;

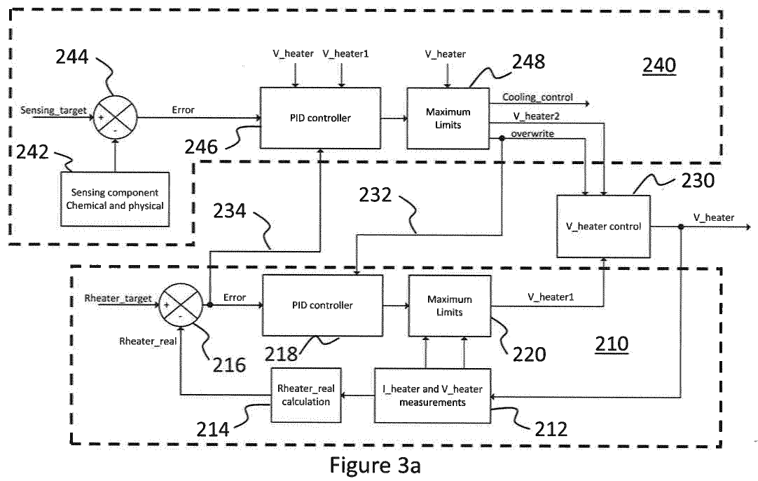

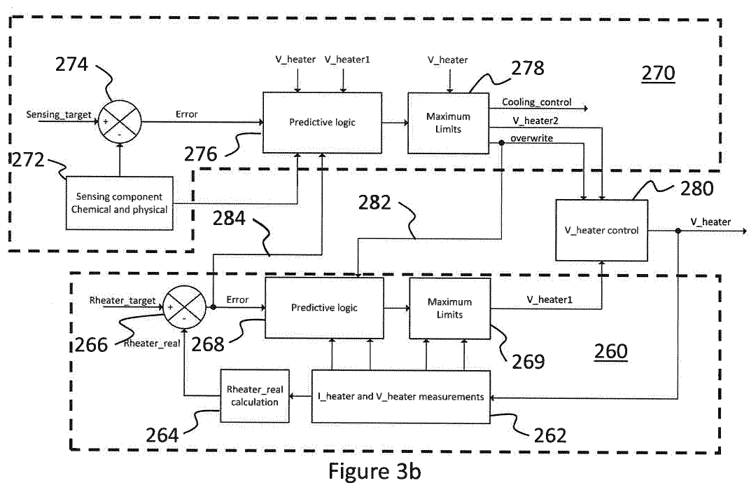

FIGS. 3a and 3b are flow diagrams respectively showing a controller having PID controllers and predictive logic control;

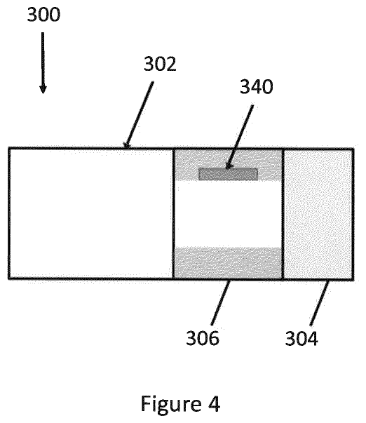

FIG. 4 is an illustrative view showing an aerosol sensor integrally formed with an aerosol-forming article according to yet another embodiment of the present invention;

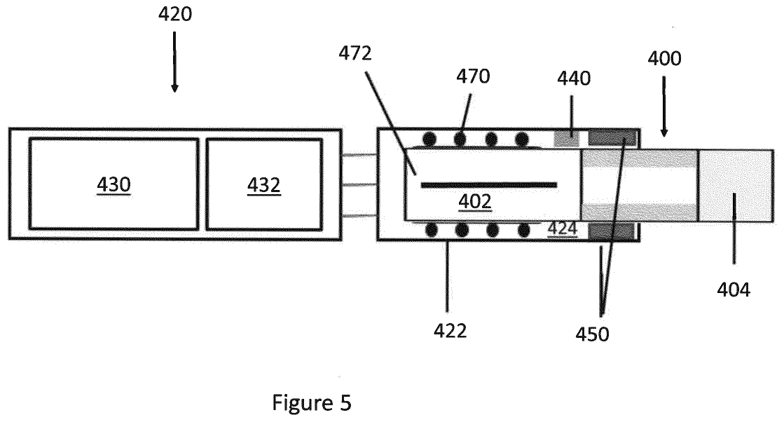

FIG. 5 is an illustrative view showing an aerosol generating system with an induction heating element according to another embodiment of the present invention; and

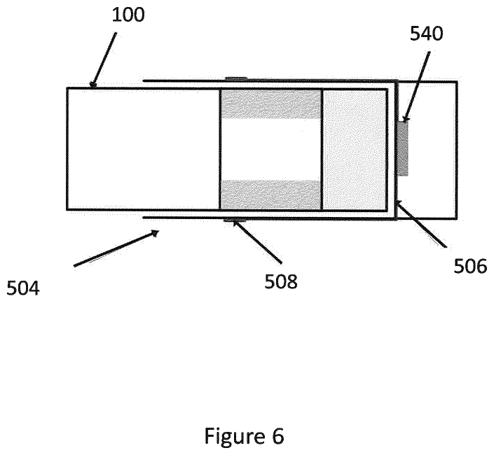

FIG. 6 is an illustrative view showing an aerosol sensor formed with a mouthpiece according to another embodiment of the present invention.

FIG. 1a shows an aerosol-generating system 10 comprising an aerosol-generating device 20 and an aerosol-forming article 100 for use with the aerosol-generating device 20. The aerosol-forming article 100 in this illustrated example is a tobacco plug having a consumable portion 102 containing an aerosol-forming substrate, a mouthpiece 104 for drawing generated aerosol through the article and an intermediate portion 106 in between the aerosol-forming substrate 102 and the mouthpiece 104.

The aerosol-generating device 20 comprises a tubular housing 22 having a cavity 24 configured to receive the aerosol-forming article 100 through an opening at a proximal end of the housing 22. When the aerosol-forming article 100 is inserted into the cavity 24, a heating element 26 in the cavity 24 penetrates and fully embeds itself into the consumable portion 102 of the aerosol-forming article 100 so as to provide heating to the aerosol-forming substrate 102, as shown in FIG. 1b. The heating element 26 is a resistive heating element that generates heat when a current is passed through it. In use the heating element 26 is heated to an operating temperature of between 200 and 350 degrees centigrade to generate an aerosol. The heating element 26 is in the shape of a blade so as to facilitate its penetration into the aerosol-forming substrate 102 when it is inserted into the cavity. The heating element 26 is sized and positioned to correspond to the consumable portion 102 of the aerosol-forming article 100 as received in the cavity 24, such that in use the whole or parts of the consumable portion 102 in a first cavity portion 24a can be heated.

The device 10 comprises an electrical energy supply 30 in the housing 22, for example a rechargeable lithium ion battery. The device further comprises a controller 32 connected to the heating element 26, the electrical energy supply 30 and a user interface 34. In this case, the user interface 34 is a mechanical button. Upon activating the user interface 34, the controller 32 controls the power supplied, via electrical connections 27, to the heating element 26 in order to regulate the temperature of the aerosol-forming substrate 102. The controller 32 further comprises a processor 38 for analyzing measured data from at least one sensor. For example, the controller may be configured to convert a detected electrical resistance across the heating element 26 into a heater temperature based on a conversion rule stored in memory 36. The memory 36 may also be configured to store a time history of measured temperature so as to provide sensor data to the processor 32 as required.

The controller 32 further comprises a communication module 39 for communicating with external devices. In this way, process parameters such as expected values of aerosol properties and heater operating temperature, may be changes from an external device connected through the communication module. Firmware updates may be provided. Data relating to device usage and device condition may be uploaded from the device to an external device. In the illustrated example, the communication module is a Bluetooth Low Energy (BLE) device capable of providing wireless communication with external devices. In some cases, the wireless communication module is not provided at the controller 32, but on an auxiliary device such as a charger. In this case the controller may send data to or receive data from external devices through the auxiliary device.

The housing further comprises a thermal break 28, such as an insulating material, adjacent to the heating element 26 in order to separate and shield electrical components from the generated heat in the cavity 24. The thermal break also provides a seal between the cavity 24 and electronic components. The thermal break prevents any liquids in the cavity from coming into contact with the electrical components. The thermal break 28 in this example also secures the base of the heating element 26 to the housing. The thermal break supports the heating element 26 as it penetrates the aerosol-forming substrate 102 during the insertion of the aerosol-forming article 100 into the device.

In use, the heating element 26 heats up to the operating temperature and causes the aerosol-forming substrate to generate an aerosol in the cavity 24. A user may then puff on the mouthpiece 104 of the aerosol-forming article 100 to draw the generated aerosol from the cavity 24. As shown in FIG. 1b, some of the generated aerosol may overflow into a gap 60 formed between the substrate 102 and the inner walls of the cavity 24. Such an overflowed aerosol is representative of the aerosol that is being generated. An aerosol sensor 40 is provided on an inner wall of the cavity 24 for sensing one or more properties of the overflowed aerosol. The output of the aerosol sensor, which is a measured aerosol property, is then passed to the controller 32 for use in a feedback control loop.

In the illustrated example, the aerosol sensor 40, such as a miniaturized metal oxide semiconductor (MOS) sensor or a miniaturized spectrometer, for sensing one or more chemical compositions in the generated aerosol. In addition, or as an alternative, the aerosol sensor 40 may comprise one or more of an optical particle and a temperature sensor for detecting a physical property, such as the quantity, density and particle sizes of aerosol droplets, as well as the temperature of the generated aerosol. Thus, the aerosol sensor 40 is capable of providing one or more of chemical composition and physical properties of the generated aerosol.

As an example, the aerosol sensor 40 may include a chemical sensor for monitoring a composition in the generated aerosol, and in particular for detecting the level of carbon monoxide (CO) which is indicative of unwanted combustion or overheating in the aerosol-forming substrate. The controller 32 is configured to compare a measured CO level with an expected value indicative of the expected CO level in the aerosol generated during normal operation. If there is a greater amount of CO than the expected level, then the controller may determine that there is an abnormal condition.

A chemical sensor typically comprises a recognition element in connection to an analytical element. The recognition element comprises receptor sites that selectively interact with the molecules of a target chemical in the generated aerosol. The analytical element comprises electronic component for processing signals output by the recognition element.

FIG. 1c shows another embodiment of the present invention. The aerosol sensor 40 in FIG. 1b is replaced by an electrochemical coating 40b. The electrochemical coating 40b is coated on a substantial portion of the cavity 24 wall. In this embodiment, the electrochemical coating 40b is a recognition element, whilst the analytical element is integrated with the controller. The electrochemical coating is arranged to be in electrical connection with the controller. The coating returns an electrical signal to the controller upon contact with a particular target chemical in the overflowed aerosol. The electrical signal returned by the electrochemical coating is proportional to the concentration of the target chemical in the generated aerosol. If the signal from the electrochemical coating is outside of a normal or expected range, then the controller determines that there is an abnormal condition. This arrangement provides a thin chemical sensor. When there is no abnormal condition, the controller 32 may control the power supplied to the heating element 26 based on the determined temperature at the heating element 26 in a first feedback control loop. The temperature of the heating element may be measured by a discrete thermocouple at the heater or based on the instantaneous electrical resistance detected across the resistive heating element 26.

In reaction to a detected abnormal condition, such as excessive CO, the controller is configured to override the first feedback control loop and use a second feedback control loop, in which the power supplied to the heating element is controlled based on the measured aerosol quality. For example in the above discussed case, upon detecting an abnormal amount of CO, the controller ceases or reduces power supply to the heating element 26 until the measured CO level drops below the expected value, without reference to the heating element temperature.

In some embodiments, the controller is configured to use the second feedback control loop in a continuous manner, so that the power supplied to the heating element is continuously controlled based on the measured aerosol quality even during normal conditions. A measured aerosol property may be used to tune the target temperature for the heating element for example.

In some embodiments, the one or more expected aerosol properties may be changed manually or be changed upon meeting certain triggering conditions. The second feedback control loop may activate at different threshold levels. For example, the expected CO level during outdoor usage, may be reduced when the aerosol-generating device 20 is used in a confined environment. Therefore, the aerosol-generating device 20 operates at a lower operating temperature when it is used indoors. The device may detect when it is indoors using the BLE device 39.

In some embodiments, the BLE device 39 communicates with an external device, such as a mobile phone, for changing the expected value of one or more aerosol properties manually. In some other embodiments, the BLE device 39 senses its proximity to other external devices, e.g. home entertainment systems, and lowers the expected value of CO suitable for indoor use.

In some cases, when operating in second control loop, the heating element temperature used by the first feedback control loop may still be taken into account. For example, upon detecting an abnormally low amount of nicotine in the aerosol, the second feedback control loop overrides temperature control in the first control loop and increases the power supply to the heating element 26. This increases vaporization and encourages release of nicotine. In this case, as a safety measure, the controller continuously refers to the heating element temperature in the first feedback loop. The controller is configured to cease the increase in power supply if the heating element temperature reaches a predefined safety cutoff limit. The typical predefined safety cutoff limit may be between 300 and 400 degrees centigrade, but it may vary depending on the type of aerosol-forming substrate that is being heated.

In some cases, a plurality of aerosol properties are measured and the secondary control loop may control the power as supplied to the heating element 26, based on a hierarchy of a measured parameters. For example, safety cutoffs such as detection of undesirable chemical compositions may override control based on nicotine level. So upon detecting an abnormally high level of undesirable chemical compound and an abnormally low level of nicotine, the controller ceases the power supply to the heating element to reduce the level of undesirable chemical compound composition, instead of increasing heater temperature to increase nicotine release.

The aerosol-generating device as shown in FIGS. 1a and 1b further comprises an auxiliary aerosol controlling means 50 for adjusting the quality of aerosol once it has been generated at the heating element. The auxiliary aerosol controlling means 50 in the illustrated example is a Peltier device that absorbs heat from a second cavity portion 24b so as to cool down the generated aerosol flowing through the intermediate portion 106 of the aerosol-forming article 100. As shown in FIG. 2, the second cavity portion 24b is advantageously positioned downstream to the first cavity portion 24a, so that the generated aerosol is cooled prior to being drawn through the mouthpiece. This leads to a steeper cooling rate in the generated aerosol at the intermediate portion 106 and thus increases seeding and formation of more aerosol droplets. In some embodiments, the intermediate portion 106 may comprise a heat conduction material to aid the cooling of the aerosol passing through it.

In some embodiments, other auxiliary aerosol controlling means 50 may be used. For example, the auxiliary aerosol controlling means 50 may be a micro-actuators configured to adjust an expansion volume of the cavity, as well as the length of aerosol flow path, so as to vary the degree of aerosol droplet formation from vapour. The auxiliary aerosol controlling means 50 may be a variable mechanical filter, such as a micro-impactor, for filtering the generated aerosol droplets that falls outside an acceptable range.

The auxiliary aerosol controlling means 50, such as the thermoelectric device, consumes additional power from the electrical power source 30. In this illustrated example the auxiliary aerosol controlling means 50 is only applied in the second control loop for adjusting the aerosol properties once an abnormal aerosol is detected. The auxiliary aerosol controlling means 50 is not activated if the aerosol properties of the generated aerosol are determined to be within a normal operating range. Instead the auxiliary aerosol controlling means is activated as a corrective measure, to improve aerosol quality if the generated aerosol falls outside desired limits.

An optical particle sizer 40 is an example of an aerosol sensor 40, where the measured aerosol properties comprise droplet quantity and droplet size. If the droplet quantity and the droplet size are detected to be within a normal operating range, the controller 27 adopts the first feedback control loop in which the power supplied to the heating element 26 is based on a measured heater temperature. However upon detecting an abnormally low droplet density and/or reduced droplet size, the controller 27 may adopt the second feedback control loop in which it not only reduces the power supply to heating element based on the aerosol properties, also activates the thermoelectric device 50 in order to encourage droplet formation.

In some embodiments, additional aerosol sensors (not shown) may be provided to monitor the aerosol properties of the aerosol drawn out at the mouthpiece. For example the additional aerosol sensors may monitor the effectiveness of the auxiliary aerosol controlling means 50 in correcting the deficiencies in the generated aerosol. The controller 27 may be configured to control the auxiliary aerosol controlling means 50 based on the measured aerosol properties from the aerosol sensor 40, or the additional aerosol sensor, or both of the aerosol sensor 40 and the additional aerosol sensor in the secondary control loop.

The additional aerosol sensors may monitor the same aerosol properties as the aerosol sensor 40, or may monitor different aerosol properties. For example, the aerosol sensor 40 may be a spectrometer for detecting CO level, and the additional aerosol sensors may be an optical particle sizer for measuring particle quantity, or particle size, or both the particle quantity and particle size. The controller may adjust power to the heating element based on a hierarchy of aerosol and heating element properties, so that an abnormal condition in one property overrides control based on an abnormal condition in another property.

FIG. 2 shows an alternative aerosol-generating system 10b comprising an aerosol-generating device 20b for use with an aerosol-forming cartridge 100b having a liquid aerosol-forming substrate 102b. The aerosol-generating system 10b comprises the same components as the embodiment 10 as shown in FIG. 1, except that it is not configured to heat a tobacco rod. The aerosol-generating system 10b is configured to vaporize a liquid substrate 102b commonly known as e-liquid.

A mouthpiece 104b is releasably attached to the opening of the cavity 124b by a screw attachment or a clip attachment. An aerosol-forming cartridge 100b may be inserted into the cavity 124b by removing and reattaching the mouthpiece 104b. In use, the aerosol-forming cartridge 100b is inserted into the cavity 124b. The liquid substrate 102b is delivered to and heated by the heating element 26b, and in the process generates an aerosol. The generated aerosol is formed in the cavity 124b before being withdrawn from the cavity as a user puffs on a mouthpiece 104b.

Generally when the second feedback control loop is used, it may be referred to as full feedback mode. In full feedback mode the at least one aerosol property as measured by the aerosol sensor is used in a continuous feedback control loop to regulate the heating element 26, according to a control logic stored in the memory 38. The control logic may be fixed at the time of manufacture, or it can be updated by machine learning or programmed by the user of the device.

When operating in a full feedback mode, the at least one aerosol property measured at the aerosol sensor 40 is applied to modify heater temperature or other variables for controlling the auxiliary aerosol controlling means 50. An intelligent algorithm or control logic may be used, which may take into account possible false positives.

Operating in full feedback mode requires the use of relatively sensitive aerosol sensors 40, as well as dedicated control logic. In some cases where such requirements are not met, the second feedback control loop may operate in much simpler fashion where the aerosol sensor 40 simply acts as a safety switch. For example, upon sensing the presence of an undesirable chemical compound, the second control loop overrides temperature control at the heating element and switches off the device altogether. More specially, the second feedback control loop may cease the operation of the device instead of providing feedback control.

FIGS. 3a and 3b illustrates two alternative flow diagrams respectively showing proportional-integral-derivative (PID) control and predictive logic control for providing the first feedback control loop 210 and the second feedback control loop 220 in the aerosol-generating device 10. The application of PID control regulates parameters after a change is measured, whilst predictive logic control regulates parameters before and after a change is measured.

In FIG. 3a, a first feedback control loop 210 is provided to control heater temperature (based on the detected electrical resistance of the heating element, when no abnormal aerosol property is detected by the aerosol sensor 40. In a first step 212, the measurement of the current through the heating element and the voltage across the heating element are received. In a second step 224, the measurements are used to calculate the electrical resistance of the heating element. The calculated heating element resistance is compared with the target resistance in step 216 and the difference is output to a Proportional, Integral, Derivative (PID) controller in step 218. The output of the PID controller is a required value for voltage to bring the electrical resistance of the heating element towards the target resistance. Using a PID controller is a well-known technique for closed loop control. The PID controller has fixed parameters, independent of heater temperature or resistance. In step 220 the output of the PID controller is checked against maximum limits for voltage and current. If the output voltage is less than the maximum limit, it is output to the heater control block 230, otherwise a maximum voltage is output to the voltage control block 230.

The second control loop 240 receives a sensed chemical or physical property of the aerosol in step 242. The sensed property is compared with an expected value for the sensed property in step 244 to output a difference. The difference is output to a Proportional, Integral, Derivative (PID) controller in step 246. The output of the PID controller is a value for the voltage to bring the sensed aerosol property back towards a target value. In step 248 the output of the PID controller is checked against maximum limits for voltage and current. If the output voltage is less than the maximum limit, it is output to the heater control block 230, otherwise a maximum voltage is output to the voltage control block 230. The output of the second control loop 240 may also be applied to additional aerosol control devices, such as a Peltier device, as shown by the Cooling_control output.

The heater control block 230 can be configured to use the input from the first control loop 210 unless an abnormal aerosol property is detected. An abnormal aerosol property is communicated to the heater control block 230 by an overwrite signal from the second control loop.

However, the second control loop may be used continuously to fine tune the first control loop. An output of the second control loop may be input to the PID controller of the first control loop, as indicated by arrow 232. Conversely, the difference between the target resistance and measured resistance from the first control loop 210 may be input to the PID controller of the second control loop 240, as indicated by arrow 234. This may serve as a safety mechanism. For example, a resistance difference indicative of significant overheating of the heating element, which could potentially lead to combustion or damage to the heating element 26, could cause the second feedback control loop 240 to issue an overwrite signal and to cease or significantly reduce power supply to the heating element 26.

FIG. 3b shows a similar first control loop 260 and second control loop 270 using predictive control logic, in which the controller predicts the behavior of the system before an event actually takes place, based on previous experience and characterization.

In a first step 262 of the first control loop 260, the measurement of the current through the heater and the measurement of voltage are received and then in a second step 264 they are used to calculate the electrical resistance of the heating element. The calculated heating element resistance is compared with the target resistance in step 266 and the difference or error signal is output to a predictive logic controller in step 268. The predictive logic controller can be based a model or ideal heating element behavior based on a plurality of parameters, such as temperature, voltage, time, current and the error between the target resistance and the calculated resistance. As in the control loop of FIG. 3a, before the output of the predictive logic controller is used to control the DC/DC converter it is first checked if the current through the heater or required output voltage is greater than predetermined maximum limits. If the current through the heater is greater than a maximum current that the battery can deliver, then in step 269 the required value for voltage is set to the product of the maximum allowable current and the calculated heater resistance. The output is input to the heater control block 280. The second control loop 270 receives a sensed chemical or physical property of the aerosol in step 272. The sensed property is compared with an expected value for the sensed property in step 274 to output a difference. The difference is output to a Predictive Logic controller in step 276. The output of the Predictive Logic controller is a value for the voltage to bring the sensed aerosol property back towards a target value. In step 278 the output of the PID controller is checked against maximum limits for voltage and current. If the output voltage is less than the maximum limit is output to the heater control block 280, otherwise a maximum voltage is output to the voltage control block 280. The output of the second control loop may also be applied to additional aerosol control devices, such as a Peltier device, as shown by the Cooling_control output.

As in the example shown in FIG. 3a, the heater control block 230 can be configured to use the input from the first control loop 210 unless an abnormal aerosol property is detected. An abnormal aerosol property is communicated to the heater control block 230 by an overwrite signal from the second control loop 240.

However, the second control loop 240 may be used continuously to fine tune the first control loop. An output of the second control loop 240 may be input to the PID controller of the first control loop, as indicated by arrow 232. Conversely, the difference between the target resistance and measured resistance from the first control loop 210 may be input to the PID controller of the second control loop 240, as indicated by arrow 234. This may serve as a safety mechanism. For example, a resistance difference indicative of significant overheating of the heating element 26, which could potentially lead to combustion or damage to the heating element, could cause the second feedback control loop 240 to issue an overwrite signal and to cease or significantly reduce power supply to the heating element 26.

The predictive control logic is stored in memory 38 and may be frequently updated by the user, or be updated automatically with every use so as to learn user behaviors or to identify a best mode of use. For example, the controller 32 may identify that a particular user tends to prefer a cooler generated aerosol, because a time history in the memory 38 shows the user always takes a shorter puff or stops puffing altogether once the generated aerosol exceeds a specific temperature. As a result, the first feedback control loop, or the second feedback control loop, or the first feedback control loop and the second feedback control loop, may then implement predictive logic, in which the expected aerosol property is reduced to a lower value.

FIG. 4 shows an aerosol-forming article 300 according to another embodiment of the present invention. Similar to the aerosol-forming article 100 in FIG. 1, the aerosol-forming article 300 also comprises a consumable portion 302 containing an aerosol-forming substrate, a mouthpiece 304 and an intermediate portion 306 in between the aerosol-forming substrate 302 and the mouthpiece 304. In this embodiment, an aerosol sensor 340 is integrally formed with the intermediate portion 306 of the aerosol-forming article 300. The aerosol sensor 340 may be a disposable sensor with the aerosol-forming article 300.

The aerosol sensor 340 is configured to detect at least one aerosol property in a main aerosol stream that is being drawn out at the mouthpiece, which allows accurate measurements to be taken. In the illustrated example, the aerosol sensor 340 connects wirelessly with the various components in the aerosol-generating device 10. For example, the aerosol sensor 340 communicates with the controller 32 using near-field communication (NFC), whilst acquiring a supply of power from the electrical power source 30 by wireless charging such as inductive charging. Alternatively, the aerosol sensor 340 may be provided with electrical connectors at the external surface of the aerosol-forming article 300 for establishing physical electrical connections with the controller 32 and the electrical power source 30.

FIG. 5 illustrates an alternative aerosol-generating device 420 comprising a controller 432 connected to an electrical power source 430, an aerosol sensor 440, an auxiliary aerosol controlling means 450 and an inductor coil 470 within the housing 422 but arranged around the external surface of an aerosol-forming substrate 402 in an aerosol-forming article 400 received in the cavity 424. The aerosol-forming article comprises a mouthpiece 404 for the user to puff on. The aerosol-generating device 420 adopts the first feedback control loop, or the second feedback control loop, or both the first feedback control loop and the second feedback control loop for controlling aerosol generation in a manner similar to the aerosol-generating device 20 as shown in FIGS. 1 and 2.

The inductive coil 470 produces an alternating electromagnetic field that induces a heat generating eddy current in an susceptor 472. Heat may also be generated by hysteresis losses in the susceptor. The susceptor 472 in this example is formed from stainless steel. The susceptor 472 is embedded in the aerosol-forming substrate 402 to heat up the aerosol-forming substrate 402 from the inside. In some embodiments, the susceptor may also be deposited on the external surface of the aerosol-forming substrate 402 to provide heating from the exterior of the aerosol-forming substrate 402. Alternatively the susceptor may be a susceptor tube surrounding the cavity 424.

The susceptor 472, as energized by the inductive coil 470, forms the heating element in this embodiment. In contrast to a conventional resistive heating element, the temperature at the susceptor 472 cannot be measured directly. Instead, the controller is arranged to determine the temperature at the susceptor 472 based on an apparent ohmic resistance across the inductive coil. Such apparent ohmic resistance can be calculated based on the voltage and current as drawn from the electrical power source. The temperature at the susceptor 472 can be taken as the heater temperature for providing feedback control in the first feedback control loop.

FIG. 6 shows a mouthpiece 504 for releasably closing a cavity of an aerosol-generating device in yet another embodiment of the present invention. The mouthpiece comprises a flow channel and a permeable mesh 506 extending across a flow channel. The mouthpiece 504 further comprises an aerosol sensor 540 mounted on the permeable mesh 506. The aerosol sensor is positioned in the path of generated aerosol for sensing at least one aerosol property of an aerosol generated from the aerosol-forming substrate. The mouthpiece further comprises electrical connectors positioned along its sidewalls for establishing physical electrical connections with the controller 32 and the electrical power source 30 as it is attached to an opening of the cavity. However, such physical electrical connection may be replaced by wireless communication such as NFC and induction charging.

The arrangement as shown in FIG. 6 allows at least one aerosol property in the main aerosol stream to be detected with a non-disposable aerosol sensor 540. Thus it is a cheaper system to run in comparison to the disposable aerosol sensor 340 as shown in FIG. 4.

The exemplary embodiments described above illustrate but are not limiting. In view of the above discussed exemplary embodiments, other embodiments consistent with the above exemplary embodiments will now be apparent to one of ordinary skill in the art.

1.-13. (canceled)

14. An aerosol-generating device, comprising:
a heating element configured to heat an aerosol-forming substrate to generate an aerosol;
a temperature sensor configured to measure a temperature of the heating element;
an aerosol-monitoring means for measuring an aerosol property comprising at least one of a physical property and a chemical composition of a generated aerosol, wherein the aerosol-monitoring means is disposed at or along a flow channel downstream of the heating element;
a controller configured to adjust a power supplied to the heating element based on:
i) a measured heating element temperature in a first feedback control loop, and
ii) a measured aerosol property in a second feedback control loop; and
an auxiliary aerosol controlling means for adjusting aerosol properties of the generated aerosol,
wherein the controller is further configured to adjust at least one control variable for the auxiliary aerosol controlling means based on the measured aerosol property in the second feedback control loop.

15. The aerosol-generating device of claim 14,
wherein the controller is further configured to compare the measured aerosol property with an expected aerosol property to determine if there is an abnormal condition, and
wherein the controller is further configured to adjust the power supplied to the heating element based on the first feedback loop if there is no abnormal condition and based on the second feedback control loop if there is an abnormal condition.

16. The aerosol-generating device of claim 14, wherein the auxiliary aerosol controlling means is configured to cool the generated aerosol.

17. The aerosol-generating device of claim 14, further comprising an aerosol-generating chamber for generating the aerosol, and wherein the auxiliary aerosol controlling means comprises an actuator configured to vary a volume of the aerosol-generating chamber.

18. The aerosol-generating device of claim 17, wherein the actuator is further configured to vary a volume of the aerosol-generating chamber by adjusting a length of the aerosol-generating chamber or a shape of the aerosol-generating chamber.

19. The aerosol-generating device of claim 14, wherein the auxiliary aerosol controlling means comprises a variable filter.

20. The aerosol-generating device of claim 19, wherein the variable filter comprises at least one of a micro-impactor and a sieve.

21. The aerosol-generating device of claim 14, wherein the aerosol-monitoring means comprises at least one of a spectrometer, an electro-chemical sensor, and a metal oxide semiconductor (MOS) sensor.

22. The aerosol-generating device of claim 14, further comprising a memory having stored thereon a predictive control algorithm or a proportional integral derivative algorithm, wherein the controller is further configured to implement the first feedback control loop, or the second feedback control loop, or both the first feedback control loop and the second feedback control loop, using either the predictive control algorithm or the proportional integral derivative algorithm.

23. The aerosol-generating device of claim 14, wherein the physical property of the generated aerosol comprises one or more of droplet density, temperature, droplet size, droplet velocity, and volumetric flow rate of the generated aerosol.

24. An aerosol-generating system comprising the aerosol-generating device of claim 14 and an aerosol-forming substrate.

25. The aerosol-generating system of claim 24, wherein the aerosol-forming substrate comprises the aerosol-monitoring means.

26. A method of varying an aerosol property of an aerosol, the method comprising:
i) generating the aerosol from an aerosol-forming substrate with a heating element;
ii) measuring a temperature at the heating element;
iii) adjusting a power supplied to the heating element based on the measured temperature in a first feedback control loop;
iv) measuring the aerosol property of the generated aerosol at or along a flow channel downstream of the heating element, wherein the aerosol property comprises at least one physical property or chemical composition of the generated aerosol;
v) comparing the measured aerosol property with an expected aerosol property to determine if there is an abnormal condition;
vi) adjusting the power supplied to the heating element based on the first feedback control loop if there is no abnormal condition;
vii) adjusting the power supplied to the heating element based on the measured aerosol property in a second feedback control loop if there is the abnormal condition; and
viii) adjusting at least one control variable for adjusting aerosol properties of the generated aerosol using an auxiliary aerosol controlling means based on the measured aerosol property in the second feedback control loop.
